(19) United States
(12) Patent Application Publication
(10) Pub. No.: US 2002/0004718 A1
(43) Pub. Date: Jan. 10, 2002

(54) Audio encoder and psychoacoustic analyzing method therefor

(75) Inventors: Satoshi Hasegawa, Tokyo (JP); Yuichiro Takamizawa, Tokyo (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/898,639

(22) Filed: Jul. 3, 2001

(30) Foreign Application Priority Data
Jul. 5, 2000 (JP) 203157/2000

(51) Int. Cl. G10L 19/02

(52) U.S. Cl. 704/229

(57) ABSTRACT

A sub-band dividing unit divides an input signal into a plurality of frequency bands, and outputs a plurality of sub-band signals. A scaling unit calculates a scaling factor related to a reference value for each of the sub-band signals, and uniformly adjusts the dynamic range thereof. An auditory-sense-analysis bit allocating unit performs weighting conforming to an equal-loudness curve for each of the sub-band signals, and then calculates the amount of bit allocation to equalize a weighted quantization error in the individual sub-band signals. A quantization unit performs quantization calculations. A bitstream generating unit generates a bitstream together with header information and auxiliary information.

### BACKGROUND OF THE INVENTION

1. Field of the Invention

The present invention relates to an audio encoder and a psychoacoustic analyzing method to be used with the audio encoder. Particularly, the present invention relates to audio-encoding processing such as an MPEG method (MPEG: Moving Picture Experts Group) using human psychoacoustics.

2. Description of the Related Art

As is conventionally known, audio-encoding processing such as the MPEG method uses the human psychoacoustics. The audio-encoding processing is performed according to software that operates under the control of a central processing unit (CPU) in an information processor, such as a personal computer. However, the audio-encoding processing based on the human auditory perceptibility, which is called a psychoacoustic model, is limited in practical application. For example, when processing, the processing load greatly increases during a masking-effect calculation step.

Depending on the performance of a processor, particularly, when realtime encoding is performed, encoding processing is delayed, and this causes audio discontinuities in decoding.

FIG. 1 shows a configuration of an audio encoder using an MPEG-1/Audio-Layer-1 method used for the aforementioned encoding processing. In the figure, an audio encoder 2 receives input audio data as an input signal, and outputs encoded audio data. The audio encoder 2 has a sub-band dividing unit 21, a scaling unit 22, a bit-allocating unit 23, a quantization unit 24, a bitstream generating unit 25, and a psychoacoustic analyzing unit 26 using a psychoacoustic model.

The sub-band dividing unit 21 divides the input signal into a plurality of frequency bands, and outputs the plurality of divided sub-bands. The scaling unit 22 calculates scaling factors, and uniformly adjusts dynamic ranges.

The psychoacoustic analyzing unit 26 obtains a ratio at which an audio signal is masked, in each of the sub-band signals. According to the ratio obtained in the psychoacoustic analyzing unit 26, the bit-allocating unit 23 allocates bits to each of the sub-band signals. The quantization unit 24 performs a quantizing calculation for each of the signals output from the bit-allocating unit 23. The bitstream generating unit 25 generates a bitstream together with a header and auxiliary information, and outputs it as the encoded audio data.

FIG. 2 shows a configuration of the psychoacoustic analyzing unit 26. In the figure, the psychoacoustic analyzing unit 26 receives the input audio data as the input signal, and outputs bit allocation information. The psychoacoustic analyzing unit 26 has a fast Fourier transform unit 31 (FFT unit), a spectrum detecting unit 32, a masking-threshold calculating unit 33, a signal-to-mask-ratio calculating unit 34 (SMR calculating unit), and a sound-pressure level calculating unit 35.

In the psychoacoustic analyzing unit 26, the FFT unit 31 performs a spectral resolution for the input audio data. In the resolved spectra, the spectrum detecting unit 32 only detects a spectrum that can be used as a masker. For the spectra detected by the spectrum detecting unit 32, the masking-threshold calculating unit 33 performs processing such as comparison to a minimum audible threshold and a masking-effect analysis, and then calculates the amount of masking for each of the sub-band signals. The sound-pressure level calculating unit 35 calculates the sound-pressure level of each of the sub-band signals.

Finally, for each of the sub-band signals, the SMR calculating unit 34 calculates a signal-to-mask ratio (SMR) by using the sound-pressure level received from the sound-pressure level calculating unit 35 and the amount of masking received from the masking-threshold calculating unit 33. Then, the SMR calculating unit 34 outputs the calculation result to the bit-allocating unit 23 (shown in FIG. 1).

Hereinbelow, referring to FIG. 3, operation of the bit-allocating unit 23 will be described.

The quantization step value of each of the sub-band signals is initialized to “0” (step S31). Subsequently, a mask-to-noise ratio (MNR) is calculated as the amount of masking for each of the sub-band signals (step S32).

Based on the results of the calculations, the quantization step value of the sub-band signal having a minimum MNR is incremented by one step (step S33) to thereby update the MNR (step S34). Then, the total number of symbols currently allocated is obtained (step S35), and it is compared with an allowable number of symbols (step S36).

If the total number of symbols has not yet reached the allowable number of symbols, processing returns to the step S31, and continues the bit allocation. If the total number of symbols has reached the allowable number of symbols, the bit-allocating processing terminates.

However, the above-described conventional audio-encoding processing according to the human auditory perceptibility generally called a psychoacoustic model is limited for practical application. When processing, the processing load increases during the masking-effect calculation step. In addition, the number of loop iterations is increased, thereby causing the problem of increasing the processing load. This is because, in the bit allocation processing, bits are allocated in order from those sub-bands which are high in the bit allocation order of priority.

Other known audio-encoding processing methods will be described below.

Japanese Unexamined Patent Publication No. 10-304360 (304360/1998) discloses load-reducing methods for audio-encoding processing. This publication discloses three methods that achieve audio-encoding processing without performing a psychoacoustic analysis that requires the highest load in the audio-encoding processing.

In a first method, bits are unconditionally allocated to a sub-band signal representing sound having a high perceptibility to the human auditory sense regardless of the sound-pressure levels of individual sound-pressure levels. In the first method, a case can occur in which bits are allocated even for a sub-band signal that has almost no sound pressure.

In a second method, sound represented by an sub-band signal is weighted according to the level of perceptibility in the human auditory senses, and the ratio of bits to be allocated to each of the sub-band signals is obtained according to the sound pressure of each of the sub-band signals. Then, bits are allocated to the individual sub-band signals corresponding to the ratios obtained in the above manner.

In a third method, sound represented by a sub-band signal is weighted according to the level of perceptibility to the human auditory senses. Then, bit-allocation priority (called a bit-allocation information coefficient) is obtained for each of the sub-band signals according to the scaling factor of the sub-band signal. Subsequently, bits are allocated in order from those sub-band signals which are high in the bit allocation order of priority.

Japanese Patent No. 2558997 disclose a method that reduces the load of audio-encoding processing by performing two types of weighting for individual sub-band signals. The first type of weighting is performed according to a logarithmic value representing the level of each of the sub-band signals. A second type of weighting is predetermined for each of the sub-band signals. The first type of weighting is proposed as a substitute of psychoacoustic analyzing processing.

In addition, Japanese Unexamined Patent Publication No. 11-330977 (330977/1999) discloses a method that ranks individual sub-band signals according to quantization errors. In the method, the sub-band signal that produces a large quantization error is not encoded, and only a sub-band signal that produces a small quantization error is allocated with encoding bits. This method allows encoding efficiency to be improved while maintaining the audio quality. Since this method adaptively varies the frequency range of the signal that is due to be encoded, it is called an “adaptive scalable coding”.

As described above, these methods reduce the load of audio-encoding processing. However, not one of the methods implements psychoacoustic processing through a small number of operations for reducing the load of audio-encoding processing.

### SUMMARY OF THE INVENTION

Under the circumstances described above, an object of the present invention is to provide an audio encoder that implements psychoacoustic analyzing processing through a minimized number of operations in audio-encoding processing and that implements efficient audio encoding at a minimized processing load.

Another object of the present invention is to provide a psychoacoustic analyzing method to be used with the aforementioned audio encoder.

An audio encoder of the present invention includes a sub-band dividing unit for dividing an input signal into a plurality of frequency bands and outputs a plurality of sub-band signals, and performs compression-encoding for the individual sub-band signals. The audio encoder further comprises a bit-allocating unit. The bit-allocating unit performs weighting in conformity to an equal-loudness curve that connects points representing pressure values of sounds having the same auditory loudness level for each frequency of the individual sub-band signal. In addition, the bit-allocating unit performs bit allocation to equalize a weighted quantization error in individual sub-band signals.

A psychoacoustic analyzing method of the present invention is applied to an audio encoder that comprises a sub-band dividing unit for dividing an input signal into a plurality of frequency bands and outputs a plurality of divided sub-band signals and that performs compression-encoding for the individual sub-band signals divided by the sub-band dividing unit. The psychoacoustic analyzing method includes the steps of performing weighting in conformity to an equal-loudness curve that connects points representing pressure values of sounds having the same auditory loudness level for each frequency of the individual sub-band signals. In addition, the psychoacoustic analyzing method includes the step of performing bit allocation that is performed to equalize a weighted quantization error in the individual sub-band signals.

The psychoacoustic analyzing method of the present invention provides an efficient psychoacoustic analyzing technique that can be implemented at a minimized processing load in an audio-encoding method according to, for example, MPEG standards, which incorporates the consideration of the human auditory senses.

A psychoacoustic analyzing technique according to the MPEG standards incorporates consideration regarding, for example, limitations of processing employing human auditory perceptibility and masking effects to thereby determine the priority of allocating bits to the individual sub-band signals. In the specifications of the standards, the human auditory perceptibility is referred to as a psychoacoustic model, and a processing procedure therefor is stipulated. In the procedure, a larger number of bits are allocated to audio bands having higher human audio perceptibility. Therefore, the technique allows encoded audio data having high audio reproduction quality to be obtained.

However, the procedure according to the MPEG standards for the psychoacoustic model starts with a FFT (fast Fourier transform), and includes other complicated high-load processing. The processing includes, for example, comparison of data of signals obtained through the FFT to a limitation of minimum auditory perceptibility, and analyses of masking effects.

The load for processing the psychoacoustic model particularly increases when the audio encoder according to the MPEG standards is implemented using software controlled by a CPU in, for example, a personal computer. The encoding performance is thus greatly influenced and limited by the performance of a processor, such as a personal computer, that implements the encoding processing. When realtime encoding processing is performed with an audio encoder having a low performance, a case can occur in which the encoding processing is delayed during playback, and the sound is thereby discontinued. The psychoacoustic analyzing method of the present invention is characterized in solving these problems.

More specifically, in the psychoacoustic analyzing method of the present invention, for individual sub-band signals, a weighting coefficient is set according to an equal-loudness curve, and in addition, an initial allowable quantization error value is set. Subsequently, for each of all the sub-band signals to which bits can be allocated, the number of quantization steps is individually calculated using the values of the scaling factor, the weighting coefficient, and the allowable quantization error of the corresponding sub-band signal.

Subsequently, the total number of symbols allocated is calculated. If the calculated total number of symbols is larger than the allowable number of symbols, a new allowable quantization error value is set, and the number of quantization steps is recalculated for each of the sub-band signals. On the other hand, if the calculated total number of symbols is equal to or smaller than the allowable number of symbols, a new allowable quantization error value is set, and then, a determination is made whether the allowable quantization error value satisfies a completion condition for the bit allocation. If the completion condition is determined not to be satisfied, the number of quantization steps is recalculated for each of the sub-band signals. If the completion condition is determined to be satisfied, the auditory-sense-analysis bit allocation processing terminates.

Conventionally, the bit-allocating processing is performed based on the result of a calculation performed using parameters of the psychoacoustic model. However, since the method of the present invention performs bit allocation to equalize a quantization error in the individual sub-band signals, encoding can be implemented with no psychoacoustic model being used.

In addition, when the weighting coefficient is set for each of the sub-band signals, the encoding bit rate that has been set is verified. If the encoding bit rate is determined to be lower than a reference value, the weighting coefficient conforming to the equal-loudness curve is reweighted according to the encoding bit rate. Thereby, the method of the present invention allows audio quality corresponding to the encoding bit rate to be maintained, allows encoding noise due to an insufficient number of symbols to be prevented, and allows encoding to be implemented corresponding to a wide range of encoding bit rates.

### BRIEF DESCRIPTION OF THE DRAWINGS

FIG. 1 is a schematic view of a configuration of a conventional MPEG-1/Audio-Layer-1 encoder;

FIG. 2 is a schematic view of a configuration of a psychoacoustic analyzing unit shown in FIG. 1;

FIG. 3 is a flowchart showing operation of a bit-allocating unit shown in FIG. 1;

FIG. 4 is a schematic view of a configuration of an audio encoder according to a first embodiment of the present invention;

FIG. 5 is a flowchart showing operation of the auditory-sense-analysis bit allocating unit shown in FIG. 4;

FIG. 6 is a weighting table in sub-band units, which conforms to an equal-loudness curve, according to the first embodiment of the present invention;

FIG. 7 shows the relationships between the numbers of quantization steps and the numbers of allocation bits in an MPEG1/Audio-Layer-1 encoding method;

FIG. 8 is a flowchart showing a method for updating a weighting table to a weighting table in sub-band units corresponding to an encoding bit rate according to a second embodiment of the present invention;

FIG. 9 is an example of a weighting table in sub-band units corresponding to encoding bit rates according to the second embodiment of the present invention; and

FIG. 10 is a flowchart showing operation of an auditory-sense-analysis bit allocating unit according to the second embodiment when an encoding bit rate is less than a recommended bit rate.

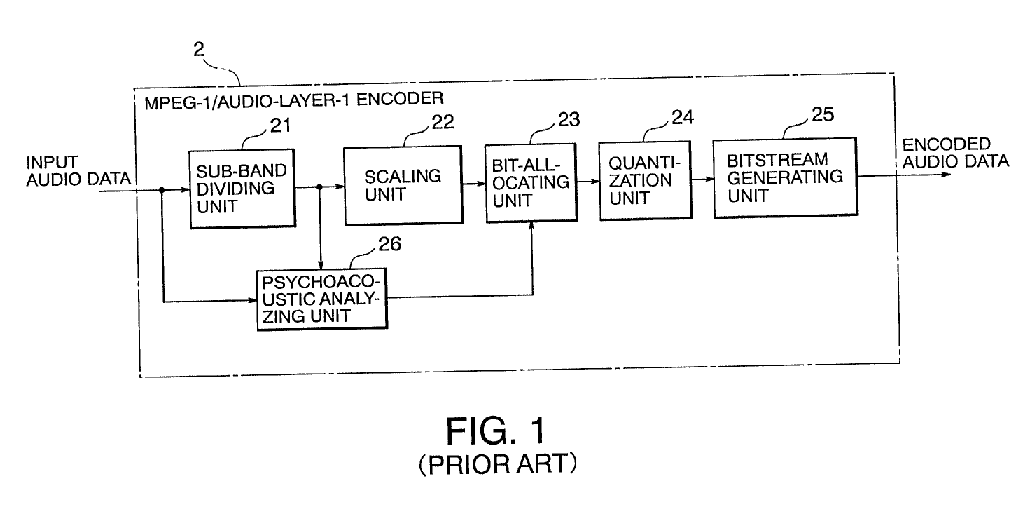

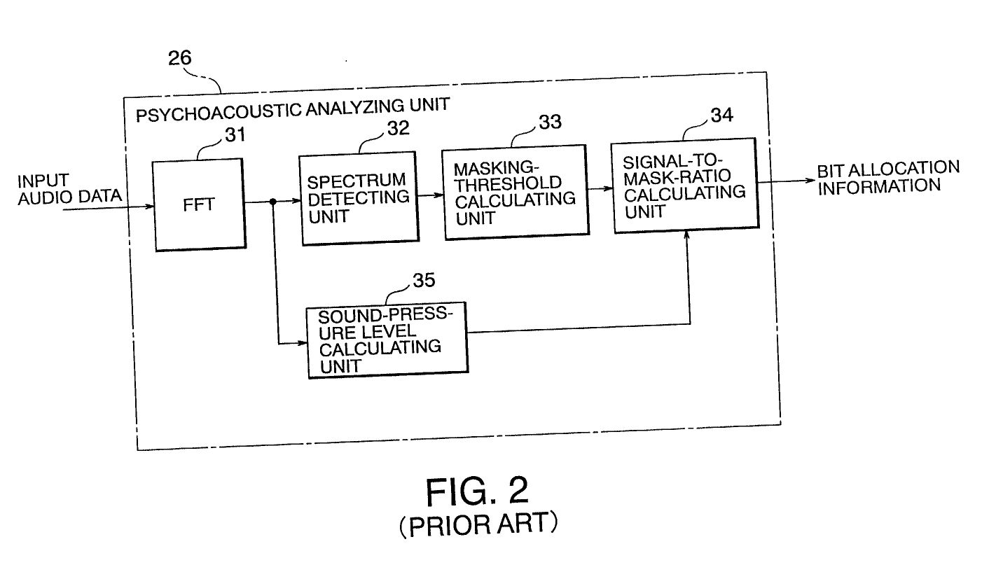

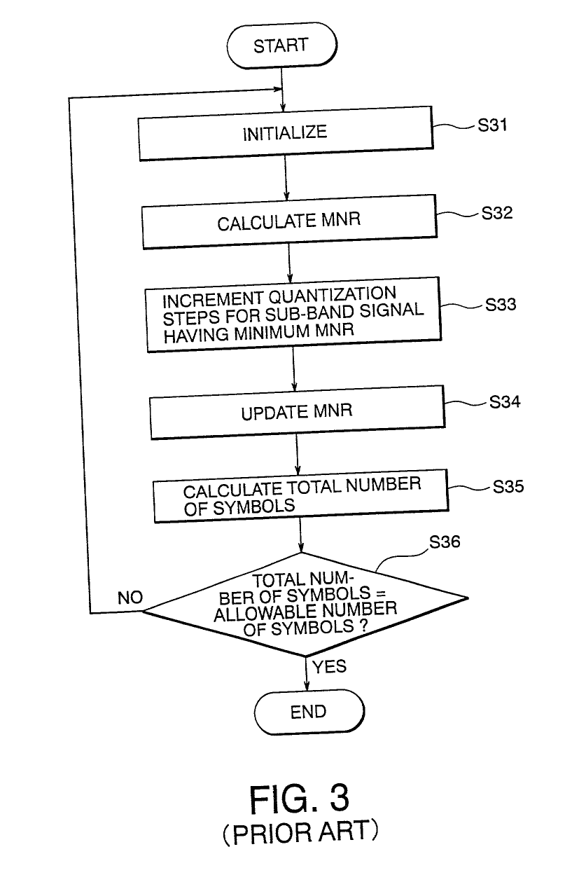

### DESCRIPTION OF THE PREFERRED EMBODIMENTS

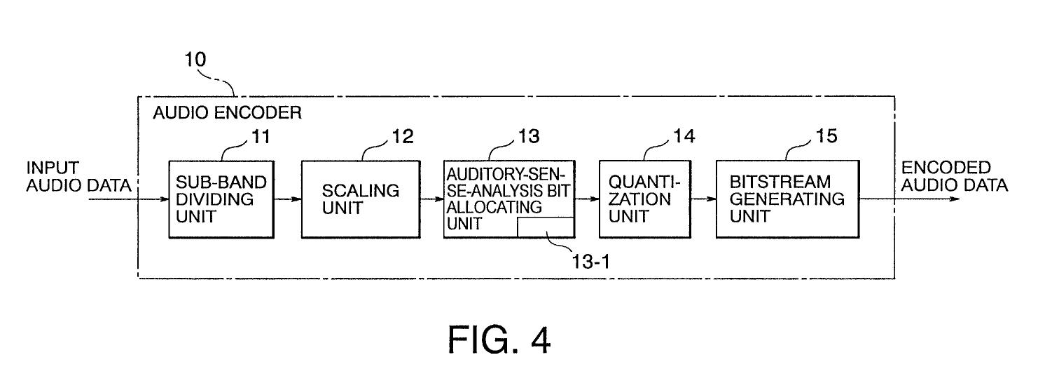

Hereinbelow, referring to FIG. 4, a description will be made regarding an audio encoder according to a first embodiment of the present invention.

In the FIG. 4, an audio encoder 10 receives input audio data as an input signal, and outputs encoded audio data. The audio encoder 10 has a sub-band dividing unit 11, a scaling unit 12, an auditory-sense-analysis bit allocating unit 13, a quantization unit 14, and a bitstream generating unit 15.

The sub-band dividing unit 11 divides the input signal into a plurality of frequency bands and outputs a plurality of divided sub-band signals. The scaling unit 12 calculates a scaling factor with respect to a reference value for each of the sub-band signals, and uniformly adjusts the dynamic range thereof.

The auditory-sense-analysis bit allocating unit 13 executes a psychoacoustic analyzing method, which is a feature of the present invention. The quantization unit 14 performs quantization calculations. The bitstream generating unit 15 generates a bitstream together with header information and auxiliary information.

The auditory-sense-analysis bit allocating unit 13 performs a weighting for each of the sub-band signals, which have been output from the scaling unit 12, according to an equal-loudness curve. Then the auditory-sense-analysis bit allocating unit 13 calculates the amount of bit allocation that allows the weighted quantization error to be equalized in the individual sub-band signals.

In addition to the weighting according to the equal-loudness curve, the auditory-sense-analysis bit allocating unit 13 can also add weights corresponding to encoding bit rates, and can calculate the amount of bit allocation that allows the weighted quantization error to be equalized in the individual sub-band signals.

The human auditory sense depends on the person. Even sound represented by a signal representing sound having the same sound-pressure level varies in the auditory loudness depending on the frequency of the signal. A curve that connects points representing pressure values of sounds having the same auditory loudness level for an individual pure-sound frequency is called an equal-loudness curve or an equal-perception curve. That is, although the sound represented by signals has the same sound-pressure level regardless of their frequency, it is heard differently depending on the auditory senses.

According to the equal-loudness curve, frequencies most perceptible to humans are in the vicinity of 4 kHz, and a frequency reduced lower than or a frequency increased higher than 4 kHz becomes difficult for a human listener to hear. Equal-loudness curves are described in detail in “Sound Oscillation Technology” (Nishiyama et al; Corona Corp; pp. 23; April 1979).

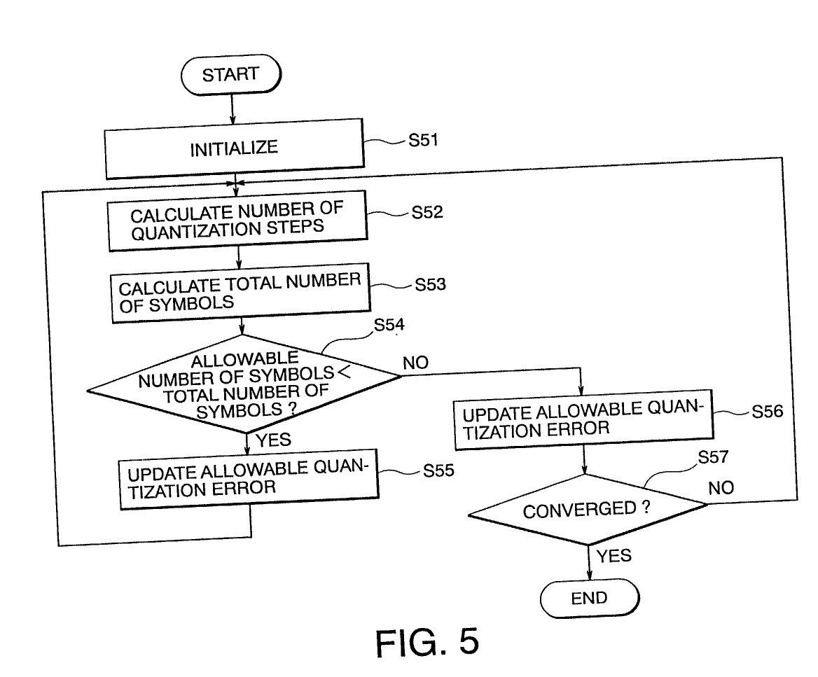

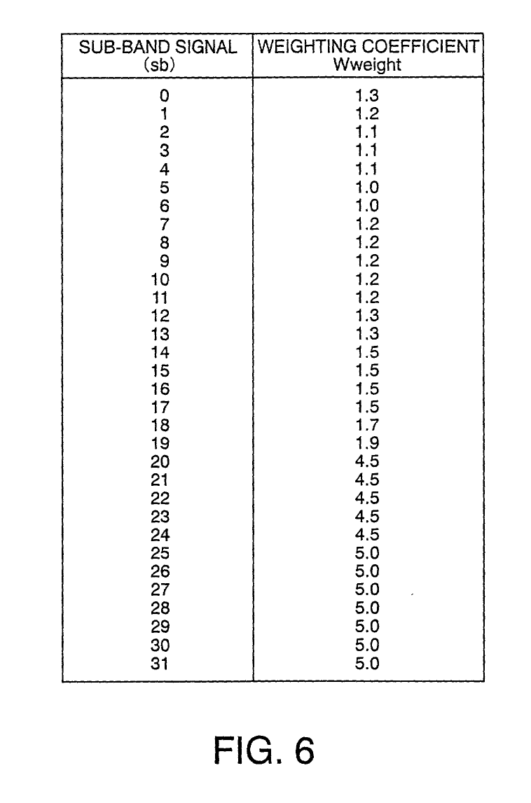

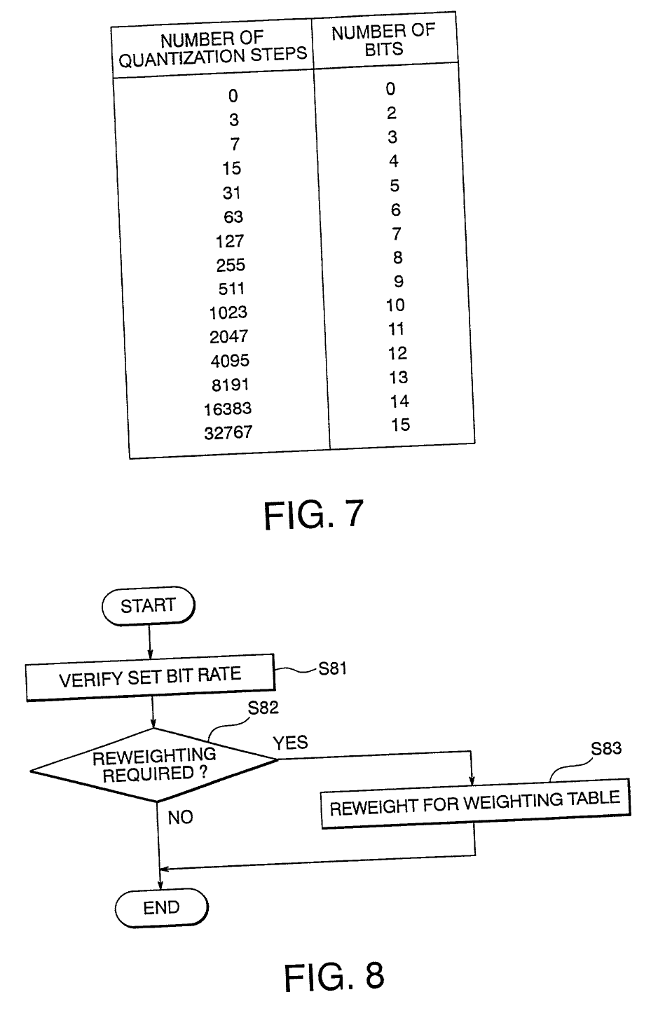

FIG. 5 is a flowchart showing the operation of the auditory-sense-analysis bit allocating unit 13 shown in FIG. 4. FIG. 6 is an example of a weighting table in sub-band units, which conforms to an equal-loudness curve, according to the first embodiment of the present invention. FIG. 7 shows the relationship between the numbers of quantization steps and the numbers of allocation bits in an MPEG-1/Audio-Layer-1 encoding method. Data representing the weighting table shown in FIG. 6 and the corresponding relation shown in FIG. 7 are stored in a memory unit 13-1 in the auditory-sense-analysis bit allocating unit 13.

Hereinbelow, referring to FIGS. 4 to 7, the psychoacoustic analyzing method according to the embodiment of the present invention will be described by way of an MPEG-1/Audio-Layer-1 encoding method as an example.

An input signal subjected to 16-bit-linear quantization is divided by the sub-band dividing unit 11 into sub-band signals of 32 bands. Subsequent processing is performed in units of 12 samples per sub-band, that is, in units of 384 samples in total. To uniformly adjust dynamic ranges of the individual sub-band signals divided into 32 frequency bands, the scaling unit 12 normalizes the ranges so that the maximum amplitude is set to 1.0, and calculates a scaling factor in units of the sub-band signal.

Subsequently, the auditory-sense-analysis bit allocating unit 13 determines the amount of bit allocation for each of the sub-band signals. First, initialization is performed (step S51 in FIG. 5). The initialization includes the determination of weighting coefficients for the individual sub-band signals. The weighting coefficients are determined according to the equal-loudness curve described above. The weighting coefficients are thus determined to allow a sub-band signal having a frequency band that is most humanly perceptible to be allocated with the largest number of bits.

According to the equal-loudness curve, determination can be made that a frequency band at about 4 kHz is most humanly perceptible. In the example, the larger the coefficient, the lower the bit-allocation priority level for the sub-band signal. In addition, the coefficient is set to 1.0 when the bit-allocation priority level is the highest.

Hereinbelow, a basic concept of the method will be described.

When the scaling factor for each of the sub-band signals is represented by Sscale(sb), and the number of quantization steps is represented by Qsteps(sb), a quantization error Qerr(sb) is expressed by the following expression:

Qerr(sb)=Sscale(sb)/Qsteps(sb)

(sb=0, 1, 2, . . . , and 31).

In addition, when the weighting coefficient for each of the sub-band signals is represented by Wweight(sb), a weighting quantization error Wqerr(sb) is expressed by the following expression:

Wqerr(sb)=Qerr(sb)×Wweight(sb)

(sb=0, 1, 2, . . . , and 31).

Bit allocation using the human psychoacoustics is implemented by controlling the number of quantization steps Qsteps(sb) to equalize the quantization error Wqerr(sb) in the individual sub-band signals, and concurrently, the value of the quantization error Wqerr(sb) is reduced to the minimum value in an allowable number of symbols.

Subsequently, an initial value is set for an allowable quantization error. The allowable quantization error refers to a value obtained by dividing a maximum scale-factor value in each of the sub-band signals by a tentatively determined maximum number of quantization steps that can be allocated to each of the sub-band signals. Therefore, the value of the allowable quantization error in this case is the minimum quantization error value.

When the maximum scale-factor value is represented by Smax_scale, and the tentative maximum number of quantization steps is “255”, the initial value of a allowable quantization error Qerr_thr is obtained through the following expression:

Qerr_{—}thr=Smax_{—}scale/255

The number of quantization steps is the number of steps through which quantization is performed. In the MPEG-1/Audio-Layer-1 encoding method, each of the numbers of quantization steps is represented by a value that is “1” less than a power of “2”, the maximum value thereof is set to “32767”, and the minimum value thereof is set to “3”. When no quantization is performed, the number of quantization steps is defaulted to “0”.

In addition, in the MPEG-1/Audio-Layer-1 encoding method, “32767” is set as a maximum number of quantization steps that can be practically allocated to each of the sub-band signals. Therefore, when this value is set, quantization can be performed with the smallest error.

When a value of “3” is set as the minimum number of quantization steps, quantization produces the largest error. From the above, a quantization error Qerr_thr_min that is smallest at an initial stage, and a quantization error Qerr_thr_max that is largest at an initial stage are expressed by the following expressions:

Qerr_{—}thr_min=Smax_{—}scale/32767

Qerr_{—}thr_max=Smax_{—}scale/3.

These expressions are used to determine whether the quantization error is within a specified limit when the total number of symbols is calculated.

Thus the initialization completes. Subsequently, processing is performed to calculate the number of quantization steps for each of the sub-band signals (step S52 in FIG. 5). A number of quantization steps Qsteps(sb) for each of the sub-band signals is obtained through the following expression:

Qsteps(sb)=Sscale(sb)×Wweight(sb)/Qerr_{—}thr

(sb=0, 1, . . . , and 31).

In this case, the obtained number of quantization steps Qsteps(sb) needs to be rounded to a specified number of quantization steps defined by the MPEG-1/Audio-Layer-1 encoding method.

FIG. 7 shows the relationship between the numbers of the quantizatin bits and the numbers of quantization steps corresponding thereto. In the present embodiment, the number of quantization steps is truncated to the nearest specification value.

Subsequently, from the number of quantization steps allocated to the individual sub-band signals, a corresponding number of quantization bits is obtained. Further, the number of bits for side information, header information, and the like required to form an MPEG-1/Audio bitstream are added. Thereby, a total number of symbols is obtained (step S53 in FIG. 5).

Subsequently, the total number of symbols is compared with the allowable number of symbols that is determined according to the encoding bit rate and that can be practically allocated (step S54 in FIG. 5). If the total number of symbols is larger than the allowable number of symbols, since the current allowable quantization error Qerr_thr can be determined to be excessively small, the allowable quantization error Qerr_thr is updated to be larger (step S55 in FIG. 5).

The allowable quantization error Qerr_thr is updated as follows. First, the current allowable quantization error Qerr_thr is stored as a new smallest quantization error Qerr_thr_min. That is, the relationship can be expressed as:

Qerr_{—}thr_min=Qerr_{—}thr.

Subsequently, a new allowable quantization error value is calculated through the following expression:

Qerr_{—}thr=(Qerr_{—}thr+Qerr_{—}thr_max)/2.

After the allowable quantization error is updated as described above, the number of quantization steps is recalculated for each of the sub-band signals (step S52 in FIG. 5).

If the total number of symbols is determined to be smaller than or equal to the allowable number of symbols, since the current allowable quantization error can be determined to be excessively large, the current allowable quantization error is updated to be smaller (step S56 in FIG. 5).

The allowable quantization error Qerr_thr is updated as follows. First, the current allowable quantization error Qerr_thr is stored as a new largest quantization error Qerr_thr_max. That is, the relationship can be expressed as:

Qerr_{—}thr_max=Qerr_{—}thr.

Subsequently, a new allowable quantization error value is calculated through the following expression:

Qerr_{—}thr=(Qerr_{—}thr+Qerr_{—}thr_min)/2.

Subsequently, a determination is made whether the bit-allocating processing according to the new allowable quantization error value has been converged. If the condition represented by the following expression is satisfied, the bit-allocating processing is determined to have been converged, and the processing therefore terminates (step S57 in FIG. 5):

Qerr_{—}thr/err_{—}thr_max>0.9.

If the above condition is not satisfied, the bit-allocating processing is determined not to have been converged. In this case, the number of quantization steps is calculated again for each of the sub-band signals by the use of the updated allowable quantization error Qerr_thr (step S52 in FIG. 5).

Subsequently, the quantization unit 14 quantizes each of the sub-band signals by using a linear quantizer that employs zero-symmetry representation. Then, the bitstream generating unit 15 generates a bitstream together with header information and side information. Thus the encoding processing completes.

According to the bit-allocation method using the psychoacoustic model specified in the MPEG standards, complicated high-load calculations are performed for analyzing FFT data, masking effects, and the like. However, as described above, the bit-allocation method of the embodiment of the present invention does not require such complicated calculations, therefore allowing the encoding processing load to be reduced.

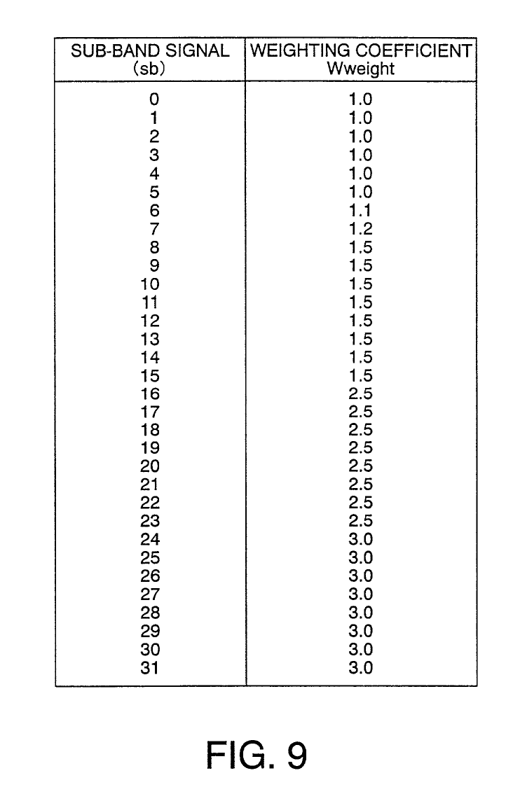

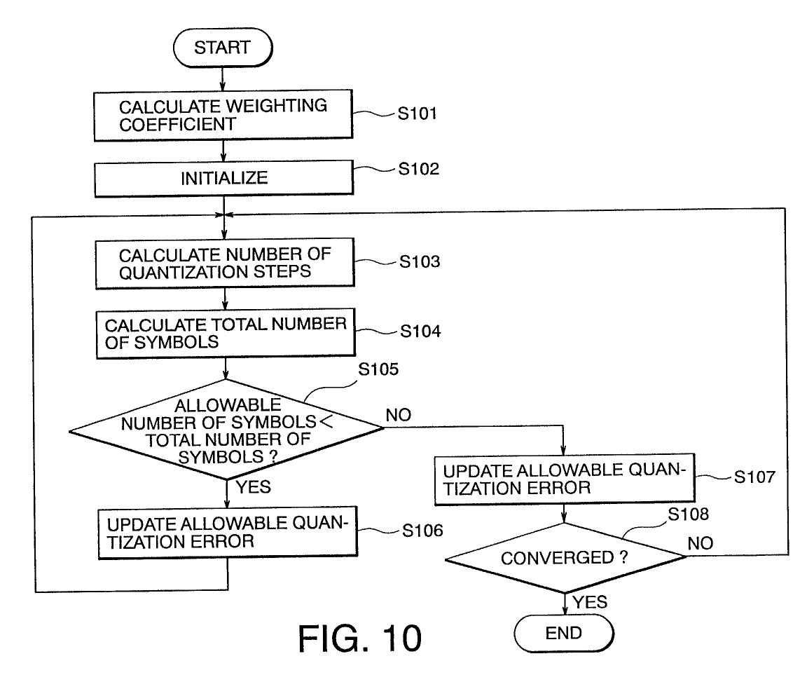

FIGS. 8 to 10 are views regarding a second embodiment of the present invention. FIG. 8 is a flowchart showing a method for updating a weighting table to a weighting table in sub-band units corresponding to an encoding bit rate. FIG. 9 is an example of a weighting table in sub-band units corresponding to an encoding bit rate. FIG. 10 is a flowchart showing the operation of the auditory-sense-analysis bit allocating unit 13 (shown in FIG. 4) when an encoding bit rate is lower than a recommended bit rate. The weighting table shown in FIG. 9 is also stored in the memory unit 13-1 in the auditory-sense-analysis bit allocating unit 13 shown in FIG. 4.

An audio encoder of this embodiment has the same configuration as that of the audio encoder 10 shown in FIG. 4, except for the operation of the auditory-sense-analysis bit allocating unit 13. Therefore, description of the same portions will be omitted. The present embodiment will be described with reference to FIGS. 4, 8, 9, and 10.

In the first embodiment described above, the weighting table conforming to the equal-loudness curve is created, and bits are allocated using the table on a prerequisite condition that bits are allocated to all the sub-band signals. In the first embodiment, however, when the encoding bit rate is low, particularly, when the encoding bit rate is lower than the recommended bit rate which is called a target bit rate, weighting performed when the encoding bit rate is high can cause a shortage in the number of allocation bits. A shortage in the allocation bits can cause degradation in the audio-quality level as well as the generation of encoding noise.

To overcome the aforementioned problems, the bit-allocation priority level for a high-audio-band-side sub-band signal is lowered, and a larger number of bits are allocated to a frequency band representing sound that can be easily perceived by a human listener. Thereby, the audio quality corresponding to the encoding bit rates can be maintained, and the generation of encoding noise can be prevented. Hereinbelow, a description will be made regarding operation that is performed when the encoding bit rate is lower than the target bit rate.

First, the encoder calculates a weighting coefficient for each of the sub-band signals (step S101 in FIG. 10). In the calculation of the weighting coefficient for each of the sub-band signals, at first, an encoding bit rate set by a user is verified (step S81 in FIG. 8). In the verification, the encoding bit rate is determined whether it is lower than the target bit rate. If the encoding bit rate is determined to be equal to or higher than the target bit rate (step S82 in FIG. 8), the encoder uses the weighting table conforming to the equal-loudness curve shown in FIG. 6.

If the encoding bit rate is determined to be lower than the target bit rate (step S82 in FIG. 8), the encoder uses a bit-rate-corresponding coefficient shown in FIG. 9 and a weighting coefficient based on the equal-loudness curve and shown in FIG. 6, to thereby calculate a new weighting coefficient (step S83 shown in FIG. 8).

When the weighting coefficient conforming to the equal-loudness curve is represented by Wweight(sb), and the bit-rate-corresponding coefficient is represented by Wweight_br(sb), a new weighting coefficient Wweight₁₃ new(sb) is obtained through the following expression:

Wweight_{—}new(sb)=Wweight(sb)×Wweight_{—}br(sb)

(sb=0, 1, 2, . . . , and 31).

Subsequently, initialization is performed to start the bit-allocating processing (step S102 in FIG. 10). If the encoding bit rate is higher than or equal to the target bit rate, Wweight(sb) is used as the weighting coefficient. If the encoding bit rate is lower than the target bit rate, Wweight_new(sb) is used as the weighting coefficient.

For the initialization, the same processing as that in step S51 in the first embodiment of the present invention is performed. Also for the subsequent bit-allocating processing (steps S103 to S108 in FIG. 10), the same processing as that in the first embodiment (steps S52 to S57 in FIG. 5) is performed, and the bit-allocating processing then terminates.

In this way, the weight corresponding to the encoding bit rate is added to each of the sub-band signals. Therefore, the audio quality corresponding to the encoding bit rate can be maintained, and the audio encoding method preventing the generation of encoding noise can be implemented.

As described above, different from the conventional method, the method of the present invention does not require the bit-allocating processing using the psychoacoustic model. The method of the present invention performs weighting for each of the sub-band signals in compliance with the equal-loudness curve, and calculates the amount of bit allocation that allows a weighted quantization error in the individual sub-band signal. Thereby, the encoding quality can be maintained, and in addition, the encoding processing load can be reduced in the audio-encoding processing including the psychoacoustic processing.

In addition, the weighting coefficient table conforming to the equal-loudness curve is provided for the individual sub-band signals, and the weighting table corresponding to the encoding bit rate is further provided therefor. The two tables are referred to perform the bit allocation corresponding to the encoding bit rate. Thereby, in the audio-encoding processing including the psychoacoustic processing, even when the encoding bit rate is low, the audio quality can be maintained with the corresponding bit rate, and the audio encoding can be performed while preventing the generation of encoding noise due to the insufficient number of symbols.

Although the individual embodiment has been described with reference to the MPEG-1/Audio-Layer-1 encoding method, the present invention can also be applied to other audio-encoding methods each having a bit-allocating means that uses a psychoacoustic model. For example, the audio-encoding methods to which the present invention can be applied include an MPEG-1/Audio-Layer-2 method, an MPEG-1/Audio-Layer-3 method, and an MPEG-2/Audio-AAC method.

In addition, the arrangement may be made such that the memory unit 13-1 stores a plurality of the encoding bit rate-corresponding weighting tables, which has been described in the second embodiment, corresponding to encoding bit rates, and the weighting tables are appropriately selected.

As described above, the audio encoder of the present invention has the sub-band dividing unit (sub-band dividing means) for dividing an input signal into a plurality of frequency bands, and performs compression-encoding for individual sub-band signals divided by the sub-band dividing means. The audio encoder of the present invention performs weighting in conformity to the equal-loudness curve that connects points representing pressure values of sounds having the same auditory loudness level for each pure-sound frequency of the individual sub-band signals, and performs bit allocation to equalize a weighted quantization error in the individual sub-band signals. This allows the psychoacoustic analyzing processing to be implemented through a reduced number of operations in the audio-encoding processing, and allows an efficient audio-coding environment wherein the processing load is reduced to be realized.

Furthermore, in addition to the weighting to be performed for the individual sub-band signals in conformity to the equal-loudness curve, the present invention performs weighting corresponding to the bit rates. Thereby, even when the encoding bit rate is low, the audio quality can be maintained with the corresponding bit rate, and the audio encoding can be performed while preventing the generation of encoding noise due to the insufficient number of symbols.

What is claimed is:

1. An audio encoder including dividing means for dividing an input signal into a plurality of frequency bands and outputting a plurality of sub-band signals, and performing compression-encoding for the individual sub-band signals outputted from said dividing means, wherein said audio encoder further comprises bit-allocating means,
said bit-allocating means performing weighting in conformity to an equal-loudness curve that connects points representing pressure values of sounds having the same auditory loudness level for each frequency of the individual sub-band signals, and performing bit allocation to equalize a weighted quantization error in the individual sub-band signals.

2. An audio encoder according to claim 1, wherein
said bit-allocating means comprises a memory unit, and
said memory unit stores a table specifying weighting coefficients conforming to said equal-loudness curve for the individual sub-band signals.

3. An audio encoder according to claim 2, wherein
said memory unit further stores a weighting table specifying weighting coefficients corresponding to encoding bit rates, and
said bit-allocating means performs bit allocation to equalize a weighted quantization error corresponding to the encoding bit rate in the individual sub-band signals.

4. An audio encoder according to claim 3, wherein
said memory unit stores a plurality of weighting tables corresponding to the encoding bit rates, and
said bit-allocating means selectively uses an appropriate one of said plurality of weighting tables.

5. An audio encoder according to one of claims 1 to 4, wherein an audio-encoding method uses a psychoacoustic analysis incorporating the consideration of auditory-sense characteristics, such as limitations of human auditory capability and masking effects.

6. An audio encoder comprising:
a sub-band dividing unit for dividing an input signal into a plurality of frequency bands and outputting a plurality of divided sub-band signals;
a scaling unit for calculating scaling factors for the individual sub-band signals to uniformly adjust dynamic ranges thereof, said scaling factors representing a magnification from a reference value;
an auditory-sense-analysis bit allocating unit for performing weighting conforming to an equal-loudness curve for the individual sub-band signals and then calculating the amount of bit allocation to equalize a weighted quantization error in the individual sub-band signals;
a quantization unit for performing quantization calculations for the individual sub-band signals to which bits were allocated; and
a bitstream generating unit connected to said quantization unit to generate and output a bitstream as encoded audio data together with header and auxiliary information.

7. A psychoacoustic analyzing method to be used with an audio encoder that comprises a sub-band dividing means for dividing an input signal into a plurality of frequency bands and outputs a plurality of divided sub-band signals and that performs compression-encoding for the individual sub-band signals divided by said sub-band dividing means, comprising the steps of:
performing weighting in conformity to an equal-loudness curve that connects points representing pressure values of sounds having the same auditory loudness level for each frequency of the individual sub-band signals; and
performing bit allocation to equalize a weighted quantization error in the individual sub-band signals.

8. A psychoacoustic analyzing method according to claim 7, wherein said step of performing bit allocation performs bit allocation for the individual sub-band signals according to the contents of a table specifying weighting coefficients.

9. A psychoacoustic analyzing method according to claim 8, wherein said step of performing bit allocation performs bit allocation according to the contents of a weighting table specifying weighting coefficients corresponding to encoding bit rates to equalize a weighted quantization error corresponding to the encoding bit rate in the individual sub-band signals.

10. A psychoacoustic analyzing method according to claim 9, wherein a plurality of weighting tables corresponding to the encoding bit rates are provided, and an appropriate one of said plurality of weighting tables is selectively used.

11. A psychoacoustic analyzing method according to one of claims 7 to 10, wherein said psychoacoustic analyzing method is applied to an audio-encoding method incorporating the consideration of human-auditory-sense characteristics.
